(19) United States
(12) Patent Application Publication
(10) Pub. No.: US 2020/0208612 A1
(43) Pub. Date: Jul. 2, 2020

(54) Bionic Root Foundation for Onshore Wind Turbine Generators

(71) Applicants: Dongyuan Wang, Austin, TX (US); Jing Li, Chengdu (CN); Ying Han, Chengdu (CN)

(72) Inventors: Dongyuan Wang, Austin, TX (US); Jing Li, Chengdu (CN); Ying Han, Chengdu (CN)

(21) Appl. No.: 16/278,010

(22) Filed: Feb. 15, 2019

(30) Foreign Application Priority Data
Dec. 29, 2018 (CN) 201811630498.4

(51) Int. Cl. F03D 13/20; E02D 27/42

(52) U.S. Cl. CPC F03D 13/22; E02D 5/34; E02D 2200/1621; E02D 27/425

(57) ABSTRACT

Embodiments of the present foundation for wind turbine generators comprise four structural members: one short central hollow pier, one continued grade beam, several solid piles built below the continued grade beam, and several arm grade beams linking the structural members. All structural members are constructed of cast-in-place concrete reinforced with rebars, and all connections are fixed and rigid. The short central hollow pier positions in the center of the system, functions as a hub to take the loadings and continuously to transfer and distribute the loadings further to the continued grade beam, arranged circumferentially in outer periphery of the system, and deeper to the solid piles, through the arm grade beams, which have a varied section and embed into ground in the far end. The present foundation utilizes the ground to shape and form the structural members, no formworks, backfilling and compaction is needed.

### REFERENCES CITED

### U.S. Patent Documents

| | | |
|---|---|---|
| 1,048,993 | Dec. 31, 1912 | C. Meriwether |
| 2,347,624 | Apr. 24, 1942 | B. J. Schwendt |
| 2,706,498 | Nov. 13, 1950 | M. M. Upson |
| 2,724,261 | Nov. 22, 1955 | E. M. Renssa |
| 3,186,181 | Jun. 1, 1965 | R. K. Show et al. |
| 3,382,680 | May 14, 1968 | Tamio Takano |
| 3,600,085 | Aug. 24, 1971 | F. Vanich |
| 3,842,608 | Oct. 22, 1974 | L. A. Turzzillo |
| 3,963,056 | Jun. 15, 1976 | A. Shibuya et al. |
| 4,228,627 | Oct. 21, 1980 | J. C. O'Neill |
| 4,618,287 | Oct. 21, 1986 | F. Kinnan |
| 4,842,447 | Jun. 27, 1989 | J. J. Lin |
| 5,228,806 | Jul. 20, 1993 | C. De Medieros |
| 5,379,563 | Jan. 10, 1995 | C. R. Tinsley |
| 5,586,417, | Dec. 24, 1996 | A. Henderson |
| 5,826,387 | Oct. 27, 1998 | A. Henderson |
| 7,533,505 | May 19, 2009 | A. Henderson |
| 7,987,640 | Aug. 2, 2011 | B. Ollggard |
| 8,161,698 | Apr. 24, 2012 | P. G. Migliore |
| 9,670,909 | Jun. 6, 2017 | N. Holscher |

### BACKGROUND OF THE INVENTION

### Field of the Invention

The presented invention relates to a tree-root-like foundation for onshore wind turbine generators. The present invention is applicable to onshore wind energy industry to support wind turbine generators and tubular towers, as well as applicable to civil engineering and other large facility, if supported superstructure has a base flange.

### Background of Foundations for Onshore Wind Turbine Generators

Foundations, defined as the engineering structures embedded fully or partially in ground to support superstructure, have been used since the civilization of human beings, for different disciplines, including wind energy engineering, civil engineering, and other large facility. The foundation typically subject to compression loadings, pull-out loadings, overturning moments and fatigue loadings. The magnitude of the loadings is dependent on superstructure. Loadings from wind turbine generators (WTGs) not only are significant in magnitude, but also have cyclic characteristics since wind directions change periodically, and therefore it is important for WTG foundations to meet specific requirements to ensure the facility safe. Typical requirements for all foundations including bearing capacity, settlement, horizontal displacement etc. For WTG foundation, horizontal and rotational stiffness is particularly important to prevent excessive gapping existing between foundation and surrounding soils as well as the resonance between wind turbine generator and the foundation supporting it.

Existing foundation types that are widely used in wind industry include inverted T-type spread footings, cap with drilled piers and cap with rock anchors, etc. A connection part has to be used to connect the superstructure to foundation. For wind turbine generator foundation, anchor bolt system is widely used to connect the base flange of wind turbine tubular tower to foundation, whereas the ground at foundation bottom or piles provide resistance to the loadings or ground anchors are used to mount the foundation to the deeper ground. Particularly, the size of foundation supporting the wind turbine generators is considerably large, and the construction cost is approximately $200,000 per foundation. It is not unusual that subsurface conditions impose limitations on construction. For example, high groundwater level may bring troubles to excavating a pit for invert T-type foundation, and requires extra measures such as shoring, bracing and dewatering. In addition, excavation will remove the earth surface vegetation, and thus excavation with relatively large footprint will negatively impact on the environment.

The present tree-root-like foundation is invented to address the above challenges. The present foundation comprises one short hollow pier positioning in center of the system, one continued grade beam arranged circumferentially in outer periphery of the system, several solid piles built below the continued grade beam, and several arm grade beams which are utilized to connect the short hollow pier to the continued grade beam as well as the solid piles. The presented foundation is constructed of cast-in-place concrete reinforced with rebars. All connections for these structural members are fixed and rigid. In addition, all these structural members are embedded in ground with a stickup in the short hollow pier which elevates the foundation and matches the configuration of the base flange of the superstructure supported by the present foundation.

### Description of Related Art

Various forms of foundations utilizing general structural and function features heretofore have been known. Those included disclosed U.S. Pat. Nos. 1,048,993, 2,347,624, 2,706,498, 2,724,261, 3,186,181, 3,382,680, 3,600,085, 3,842,608, 3,963,056, 4,228,627, 4,618,287, 4,842,447, 5,228,806, 5,379,563, 5,586,417, 5,826,387, 7,533,505, 7,987,640, 8,161,698, 9,670,909, etc. However, these previously invented foundations do not include the forms and features of the instant invention, and the combined forms and features of the instant invention enable the presented invention heavy duty as well as adaptive, constructible and cost-efficient. The invented foundation comprising features disclosed results in fully utilizing the further and deeper ground to resist tremendous overturning moment loadings. The present foundation results in very low vertical and horizontal deflections with surprisingly high translational and rotational stiffness under loadings transferred from wind turbine generators. In the meanwhile, relatively lengthy arm grade beams enable the capability to lower the requirements for the bearing capacity of the solid piles, and thus the length of the solid piles is reduced.

U.S. Pat. No. 1,048,993 to C. Meriwether discloses a simple and inexpensive construction method of reinforced concrete caisson sunk by a usual way. The caisson may be filled with concrete and then works as a pier. The caisson is pre-casted into tubular sections of concrete; heavy reinforcements and metal rings which are in a bell and spigot joint are used in section ends. The rod is tensioned and extended through the connecting rings embedded partially inside of the reinforced concrete. The rod works as a tie to connect the embedded rings which are spaced inward of the inner peripheries of the concrete tube and do not embed fully in the concrete wall. The Meriwether's caisson is a concrete pier with relatively large diameter, no continued grade beam, solid piles and arm grade beams are included which transfer and distribute the loadings to further and deeper ground as the present foundation.

U.S. Pat. No. 2,374,624 to P. J. Schewendt discloses a precast foundation with concrete bolted together intended for supporting transportation signal masts. The foundation embedded in the ground, but the precast sections impose size limitations and thus the foundation can only support light superstructures which subject to relatively small overturning moment. The present foundation has forms and features which are constructed of cast-in-place concrete reinforced with rebars, to resist tremendous overturning moment loadings from tall superstructures with surprisingly high translational and rotational stiffness.

U.S. Pat. No. 2,706,498 to M. M. Upson discloses a pre-stressed tubular concrete structure for use as pipe conduits, piles and caissons. The structural tubular structure is pre-casted and can be assembled one by one with joint means at the end. Tension is applied to the longitudinal reinforcing steel placed in the preserved holes and grout then is poured to the holes to make the steel and concrete bond tightly. The Upson's structure is pre-stressed and not suitable for use as foundations for wind turbine generators or other tall structures which subject to tremendous overturning moment. The joint means the connections for the pipes are not rigid, which may cause problems in stiffness of the foundation. And, the structure would be difficult to transport to wind farm site. Enabled by the comprised forms and features which are constructed of cast-in-place reinforced concrete, the present foundation in contrast results in very high translational and rotational stiffness, and construction materials are convenient to transport to the construction site.

U.S. Pat. No. 2,724,261 to E. M. Rensaa discloses a method attaching precast concrete column to a supporting base, the diameter of the column is relatively small, and the base typically embeds in shallow subsurface. Obviously, the Rensaa's method is rather for construction, and the Rensaa's entire structure is not suitable for use as a large foundation for tall superstructure like wind turbine generators. In contrast, the present foundation is suitable to support tall superstructure enabled by comprised forms and features which transfer and distribute loadings to further and deeper ground, and the comprised structural members are constructed of cast-in-place reinforced concrete, not pre-casted.

U.S. Pat. No. 3,186,181 to R. K. Show et al. discloses a method and apparatus of filling the pile shells with concrete to address the problems caused by turbulent air that segregates the rocks from cement in long pile shells. The apparatus is a pre-compression chamber, which holds the concrete from segregating and discharges the concrete to the bottom of the pile shells. The Show's invention is rather a construction method, not as the present foundation improves structure's engineering behavior by comprised forms and features which are constructed of cast-in-place reinforced concrete to transfer and distribute loadings to further and deeper ground.

U.S. Pat. No. 3,382,680 to T. Takano discloses a pre-stressed concrete pile section comprising a tubular body of concrete with a pair of annular mental discs at opposite ends. The invention provides a pre-stressed concrete pile or pile section which results in an improved structure particularly designed to enable effective pre-tensioning of the axial reinforcement, which takes the form of reinforcing steel wires, and is high in structural strength. The pre-stressed axial reinforcing steel wires are bonded with concrete, and the steel wires have enlarged head to anchor to the steel ring embedded in concrete. Assembly the reinforcing system and applying pre-stress is cumbersome, and, the principles of the Takano's pre-stressed concrete pile is different from the present foundation, which comprises forms and features to improve the engineering behavior by transferring and distributing the loadings to further and deeper ground. The comprised forms and features are constructed of cast-in-place reinforced concrete, not using pre-stressed reinforcements.

U.S. Pat. No. 3,600,865 to F. Vanich discloses a single-column borne house erected and supported on a cast in place foundation pillar. The column is bolted to the pillar while beams are bolted to the column as cantilever beams. The foundation pillar is supported on a large diameter pile or insert into ground with a small pit which will be used to place concrete. In contrast, the present foundation comprises features and forms to transfer and distribute the tremendous loadings to further and deeper ground, that is obviously different from the Vanich's invention.

U.S. Pat. No. 3,842,608 to L. A. Turzillo discloses a method of installing a pile using screw-like means to drill the hole for the pile. Then cementitious material is then poured into the hole, and a pile is formed. The Turzillo's invention is rather a construction method than improving the engineering behavior as the present foundation by utilizing the comprised features and forms to transfer and distribute loadings to further and deeper ground.

U.S. Pat. No. 3,963,056 to A. Shibuyya et al. discloses pre-stressed concrete piles, poles or the like. Pillar covered with an outer shell of steel pipe on a circumferential surface of a cylindrical pre-stressed concrete tube or a pillar shaped pre-stressed concrete pole at least one end being in an independent state to the concrete article. The invention provides the joint effects of the good compressive strength of the said pre-stressed concrete tube or pole and the good bending strength by adding the outer shell. However, the outer steel shell filled with concrete can be regarded as increasing the pile diameter. The Shibuyya's structure is not as the present foundation improves structure's engineering behavior by comprised forms and features which transfer and distribute loadings to further and deeper ground, and the forms and features are constructed of cast-in-place reinforced concrete, not using pre-stressed reinforcements.

U.S. Pat. No. 4,228,627 to J. O'Neill discloses a reinforced foundation structure for supporting high light pole by using a plurality of vertically extending reinforcing rod assemblies with the top bolted to a base plate on the bottom of the pole. The structure extends downwardly into a vertical earth bore of relatively small diameter. Accordingly, the O'Neil Structure is not capable of being used to support superstructure subject to high overturning moment or being placed under high unit compressive loading. In contrast, the present foundation improves structure's engineering behavior by comprised forms and features which transfer and distribute loadings to further and deeper ground, and the forms and features are constructed of cast-in-place reinforced concrete.

U.S. Pat. No. 4,618,287 to F. Kinnan discloses a method for establishing in ground footings to support poles by using a threaded steel casing. The casing is threaded into ground, and grout is penetrated into the ground via the holes through the steel casing. The diameter of casing and the depth threaded into ground are relatively small. Accordingly, the Kinnan's structure is not capable of being used to support superstructure subject to high overturning moment or being placed under high unit compressive loading. The Kinnan's invention is rather a construction method than improving structure's engineering behavior as the present foundation by comprised forms and features, which transfer and distribute loadings to further and deeper ground. The forms and features of the present foundation are constructed of cast-in-place reinforced concrete, no grout is used to improve the existing ground.

U.S. Pat. No. 4,842,447 to J. J. Lin discloses a fabrication method and device of hollow reverse circulation piles. Firstly, a central hollow portion is installed with a movable sand barrel between which and the surrounding reinforcing cage, positioning device for movable sand barrel is installed. Upon start of work, grouting is poured to a scheduled height from the bottom of the pile bore first. Grouting is then poured between pile bore wall and outer wall of movable sand barrel. The Lin's invented construction method and device is expensive, and the construction process is impractical. In contrast, the present foundation improves structure's engineering behavior by comprised forms and features which transfer and distribute loadings to further and deeper ground, and the forms and features are constructed of cast-in-place reinforced concrete, and no need for extra device for construction.

U.S. Pat. No. 5,228,806 to C. J. De Medieros et al. discloses a gravity pile for subsea platform foundations. The gravity pile comprises a series of pile sections made from two concentric tubes, the annular space between which is filled with an elevated specific weight composition. Individual pile sections can be joined together by means of tubular connecting rings welded to the ends of the sections. The Medieros' foundation is complicated in construction, and thus not cost-efficient. Moreover, the welding connecting the gravity piles is vulnerable to high fatigue, cyclic loadings provided by wind turbine generators. In contrast, the present foundation improves structure's engineering behavior by comprised forms and features which transfer and distribute loadings to further and deeper ground, and the forms and features are constructed of cast-in-place reinforced concrete. The present foundation utilizes the resistance from further and deeper ground, not the weight of the foundation, to resist the tremendous overturning moment loading.

U.S. Pat. No. 5,379,563 to C. R. Tinsley discloses an anchoring assembly by which heavy machinery may be anchored to a foundation. Anchoring plates used to fasten the anchors in lower and upper part are separate. Such separated plates and anchors may be pulled out when the overturning moment is large. Thus, the Tinsley's foundation is not capable of supporting superstructures such as wind turbine generators which subject to high overturning moment. In contrast, the present foundation is suitable to support tall superstructures by bolting the base flange of the superstructure to foundation. The present foundation improves structure's engineering behavior with comprised forms and features which transfer and distribute loadings to further and deeper ground, and the forms and features are constructed of cast-in-place reinforced concrete, the embedment ring used in present foundation is intact, not separated, to ensure the pullout safety.

U.S. Pat. No. 5,586,417 to A. P. Henderson et al. discloses a hollow, cylindrical pier foundation which is constructed of cementitious material poured in situ between inner and outer cylindrical corrugated metal pipe (CMP) shells. The foundation is formed by CMPs within a ground pit. External and internal spaces beyond the CMPs need to be backfilled. The lengthy anchors are adopted to bolt the base flange of superstructures to the foundation bottom intended to make the foundation tensionless. In contrast, the present foundation does not use CMPs to form the foundation, it utilizes ground to form the foundation and no need to excavate a pit to place the foundation, and no backfill and no compaction is needed. Moreover, the present foundation comprises forms and features to transfer and distribute the tremendous overturning moment loadings from tall superstructure to further and deeper ground that the Henderson's invention does not have. The length of the bolts used in present foundation are much shorter, and the reinforcements and concrete of the present foundation take the tensions, compressions and the moments, and these loadings are transferred and distributed to further and deeper ground by the comprised forms and features. Compared with Henderson's invention, more reinforcements are used in central hollow pier to keep it as a rigid body and the usage of reinforcements decreases in other structural members with distance increasing from the foundation center. The principle and the comprised forms and features of the present foundation are obviously different from Henderson's invention.

U.S. Pat. No. 5,826,387 to A. P. Henderson et al. discloses an upright cylindrical pier foundation which is constructed of cementitious material. Compared with U.S. Pat. No. 5,586,417, the pier is formed similarly by using the corrugated metal pipe (CMP) shells, while more rods are added and arranged radically to the upper part of the system to ensure higher bearing capacity for high compression. Refer to comparisons between the present foundation with U.S. Pat. No. 5,586,417, the present foundation does not use CMPs to form the structural members, it utilizes ground to shape and form the foundation and no need to excavate a pit to place the CMPs, and no backfill and no compaction is needed. Moreover, the present foundation comprises forms and features to transfer and distribute the tremendous overturning moment loadings from tall superstructure to further and deeper ground that the Henderson's invention does not have.

U.S. Pat. No. 7,533,505 to A. P. Henderson discloses a circular concrete cap foundation poured in-situ within a perimeter forming using corrugated metal pipes (CMPs). The CMPs are set at top or within an excavated pit and enclosing a series of circumferentially spaced pile anchors. The pile anchors are also formed with corrugated metal pipes (CMPs) which are set deep in subsurface soils and poured with cementitious material. Refer to the comparisons with U.S. Pat. No. 5,586,417, the present foundation does not use CMPs to form, manufacture the comprised forms and features. The present foundation utilizes ground to shape and form the foundation and no need to excavate a pit to place CMPs, no backfill and no compaction is needed. Moreover, the present foundation comprises forms and features to transfer and distribute the tremendous overturning moment loadings from tall superstructure to further and deeper ground that the Henderson's invention does not have.

U.S. Pat. No. 7,987,640 to B. Oiigaard et al. discloses a technique preventing water intrusion into foundation by adding sealing compound and cover into foundation concrete. The technique is helpful to increase the lifetime of the foundation but not improving the mechanical behavior of the foundation by inventing forms and features.

U.S. Pat. No. 8,161,698 to P. G. Migliore discloses a circular foundation using fiber reinforced concrete with circular reinforcement rods. The foundation includes a vertical stanchion that rests on the bottom of an excavated hole with relatively large diameter, vertical anchor bolts and radical reinforcements are placed in the hole, and then concrete is poured into the hole. The invention essentially follows the principle of single pier foundation, a stanchion and radial reinforcement around the stanchion are placed within the concrete of the pier to increase the internal strength of the structure. Thus, the Migliore's invention only improves the material properties within the pier, not related to the foundation shape and interactions with surrounding soils. In contrast, the present foundation comprises forms and features to transfer and distribute the tremendous overturning moment loadings from tall superstructure to further and deeper ground, these comprised forms and features improve engineering behaviors of the present foundation greatly.

U.S. Pat. No. 9,670,909 to N. Holscher discloses a foundation constructed with a plurality of concrete segments. The segments are pre-casted with curved surfaces, and two sheaths are preserved to install tensioned wires to tie up the segments. In contrast, the present foundation comprises forms and features to transfer and distribute the tremendous overturning moment loadings from tall superstructure to further and deeper ground. The present foundation is constructed of cast-in-place concrete reinforced with rebars, not using pre-casted segments which are tied up with tensioned wires.

Based on above comparisons with state-of-the-art technique in relation to the present foundation, it is finally concluded that the present foundation comprises different forms and features from above listed inventions, and the comprised forms and features greatly improve the engineering behavior of the present foundation.

### SUMMARY OF THE INVENTION

The foundation of the instant invention is unique because the new foundation type is invented by imitating the tree root system, which is selected by nature and the roots ensure the trunk erect in wind. In summary, the short central hollow pier and solid piles circumferentially arranged in outer periphery imitate vertical tree roots, whereas the continued grade beam and the arm grade beams mimic laterally-support roots. All these members are embedded in ground and all connections for the structural members are fixed and rigid.

For a conventional concrete pier foundation, all loadings from superstructure are transferred and taken by the single pier and then the ground around the pier provides resistance to balance the loadings. This is similar for a conventional pile foundation.

For the present foundation, the short central hollow pier elevates the foundation with a stickup and its plan configuration matches the base flange of superstructures. The short central hollow pier functions as a hub to take the loadings transferred from the superstructures, and continuously to transfer and distribute the loadings further to the continued grade beam and deeper to solid piles, through the arm grade beams. The bearing capacity required for the solid piles to resist the tremendous moment loadings from superstructures is also lowered by the relatively lengthy arm grade beams, thus the length of the solid piles can be reduced. The continued grade beam functions to link all structural members, and make them work together, certainly itself also provides resistances to the loadings.

The anchor bolt system, which is widely used in industry for wind turbine generator foundation, bolts the superstructure and foundation together, and transfer loadings from superstructure to the present foundation. Thus, the foundation is loaded by the structure supported therefrom, the unit is subjected to varying tensile and compressive loads, and the tensile and compressive loads form a coupled moment to resist the overturning moment transferred from tall superstructures. In the present foundation, the anchor bolts are approximately 6 feet long which enables the embedment ring being placed at a lower position below the bottom of the arm grade beams. This length is much shorter than those typically used in other type foundations. However, resistance to pull-out loadings is ensured as the embedment ring is placed below the bottom of the arm grade beams. The more details related to mechanical analysis are described in the following paragraphs.

The tensile and compressive loads form a coupled moment that resists the overturning moment transferred from tall superstructures. More specifically, overturning moment loadings and dead weight of superstructures generate compressions on foundation top, where high-strength grouting material is used to prevent breaking of the foundation top concrete. In the meanwhile, overturning moment loadings also cause tensions in anchor bolts. The compression reaction from the high-strength grouting and the tension reaction from the anchor bolts form a coupled moment to resist the overturning moment loadings that the foundation subject. The coupled moment formed in short central hollow pier will also be transferred to continued grade beam as well as solid piles through arm grade beams which are connected to the short central hollow pier, the continued grade beam as well as solid piles. Horizontal shear that superstructure subjects to is also transferred and distributed to the foundation. The short central hollow pier takes the transferred shear and continuously transfers and distributes it to continued grade beam as well as solid piles through arm grade beams. Finally, all these loadings are transferred and distributed to further and deeper ground through the comprised forms and features of the present foundation.

The present foundation is initially intended to mimic the tree root system as well as it is working mechanism. However, the above description for mechanical analysis of the present foundation follows the principles of soil mechanics as well as the loading distribution among rigid, fix-connected structural members. Earth pressure acts on the structural members of the present foundation as they are embedded in ground. The magnitude and directions of earth pressure depend on displacement of the structural members and the embedment depth. Moreover, earth pressure interacts with the structural members and offsets the loadings transferred and distributed.

Design engineers are familiar with the comprised forms and features of the present foundation. In addition, a bunch of standards/codes that the design shall comply with are available. The design is thus conventional and not challenging. Following the principles of loading distribution among structural members and soil mechanics for embedded engineering structures, the usage of reinforcements should follow a trend decreasing from the short central hollow pier with the distance increasing from the central hollow pier. Hand calculations can provide close-form solutions for design use, while 3-D geotechnical and structural design and analysis software is better as they can provide more accurate solutions.

No special construction equipment is needed. Typical and widely-used construction equipment and construction procedure can be used to construct the present foundation. Moreover, the present foundation utilizes ground to shape and form structural members, no formworks as well as no backfill and no compaction is needed. Thus, the construction procedure is simplified, and the construction time is saved. Since the footprint of the structural members is relatively small, the removal of the earth surface vegetation is minimal, and thus, the present foundation is environment-friendly.

Finally, the invented foundation fully utilizes the further and deeper ground to resist the loadings, and ensures the present foundation meets the requirements for horizontal deflection, vertical displacement as well as translational and rotational stiffness. The present invention to be specifically enumerated herein is to provide a bionic root foundation in accordance with the proceeding forms and features of manufacture, be of simple construction, cost-efficient, environment-friendly, constructible and suitable to most subsurface conditions of the sites. All technical requirements from superstructures are more easily to be satisfied, the forms and features of the foundation comprises of are economically feasible, durable, reliable and cost-efficient.

Compared with industry-widely used invert T-type spread foundation under the same loadings with the same site conditions, approximately 30% construction cost can be saved if the present foundation is constructed accordingly. These together with other objects and advantages which will become subsequently apparent reside in the details of construction and operation as more fully hereinafter described and claimed, reference being had to the accompanying drawings forming a part hereof, wherein like numerals refer to the like parts throughout.

### BRIEF DESCRIPTION OF THE DRAWINGS

FIG. 1 is a 3-D illustration of the invented foundation. The foundation is completed constructed in accordance with the preferred embodiments of the present invention. The surrounding soil and rock masses are omitted in the sketch so the forms and features comprised in the present foundation can be seen clearly, and the invented foundation is skewed in order to show the foundation embodiment clearly. Four structural members, short central hollow pier, continued grade beam, solid piles and arm grade beams are clearly shown in FIG. 1. Reinforcements for the structural members are also partially shown in FIG. 1.

FIG. 2 is a 3-D illustration for the short central hollow pier and reinforcement arrangements. The short central hollow pier functions as a hub of taking, transferring and distributing loadings to other forms and features comprised in the present foundation. Concrete, anchoring system including base flange, embedment ring, washers and nuts as well as reinforcements are also shown in FIG. 2.

FIG. 3 is a top plan view of the invented foundation. Four major structural members and their geometry relationship are illustrated in FIG. 3.

FIG. 4 is a vertical sectional view of the invented foundation, illustrating the arrangements for the four major structural members constructed in accordance with preferred embodiments. Since the length of the arm grade beams and solid piles, break symbols are used, and only part of the labeling numerals are shown in FIG. 4.

FIG. 5 is a vertical sectional view for the short central hollow pier, reinforcements and anchoring system. The concrete shape, the anchoring system and reinforcements arranged in accordance with the invented foundation during construction are illustrated.

FIG. 6 shows the detail for vertical sectional view of anchor bolts and the base flange. Anchor bolts, PVC wrap, base flange as well as washers and nuts assembled in accordance with the present foundation are illustrated.

FIG. 7 shows the detail for vertical sectional view of anchor bolts and embedment ring. Anchor bolts, PVC wrap, Embedment Ring as well as washers and nuts assembled in accordance with the present foundation are illustrated.

FIG. 8 shows the detail for cross-sectional view of continued grade beam and reinforcements. The reinforcements arrangements during construction in accordance with the present foundation are mainly illustrated.

FIG. 9 shows the details for 3-D illustration and sectional view for connection of arm grade beam to central hollow pier with reinforcements. How these structural members connect to each other and how to arrange the reinforcements during construction in accordance with the present foundation are mainly illustrated.

FIG. 10 shows the details for 3-D illustration and sectional view for connection of continued grade beam, solid pile and arm grade beam with reinforcements. How these structural members connect to each other and how to arrange the reinforcements during construction in accordance with the present foundation are mainly illustrated.

FIG. 11 is a 3-D illustration and sectional view of solid piles with reinforcements, illustrating the reinforcement arrangements during construction in accordance with the present foundation.

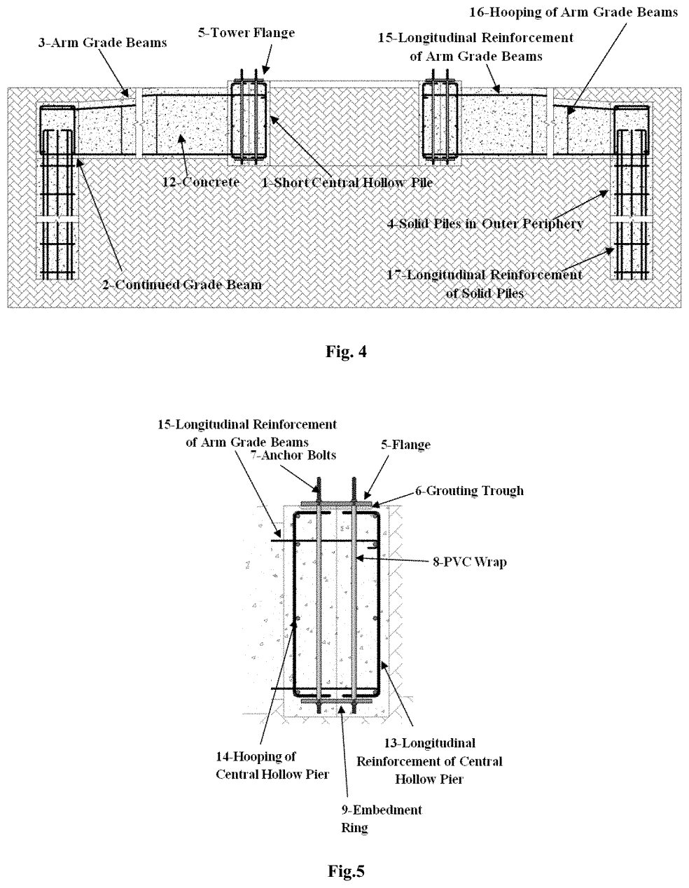

Designations for numerals in FIGS. 4,5, 6,7,8,9,10 and 11 are as follows:

1—Short Central Hollow Pier; 2—Continued Grade Beam; 3—Arm Grade Beams; 4—Solid Piles in Outer Periphery of the System; 5—Tower Flange; 6—Grouting Trough; 7—Anchor Bolts; 8—PVC Wrap; 9—Embedment Ring; 10—Washers; 11—Nuts; 12—Concrete; 13—Longitudinal reinforcements of Central Hollow Pier; 14—Hooping of Central Hollow Pier; 15—Longitudinal Reinforcements of Arm Grade Beams; 16—Hooping of Arm Grade Beams; 17—Longitudinal Reinforcements of Solid Piles; 18—Hooping of Continued Grade Beam; 19—Longitudinal Reinforcements of Continued Grade Beam; 20—Preserved Holes in Flange; 21—Predrilled Holes in Embedment Rings; 22—Hooping of Solid Piles

### DESCRIPTION OF THE PREFERRED EMBODIMENTS

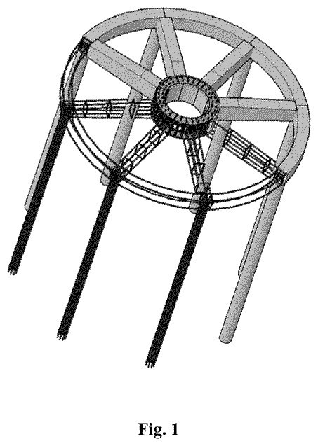

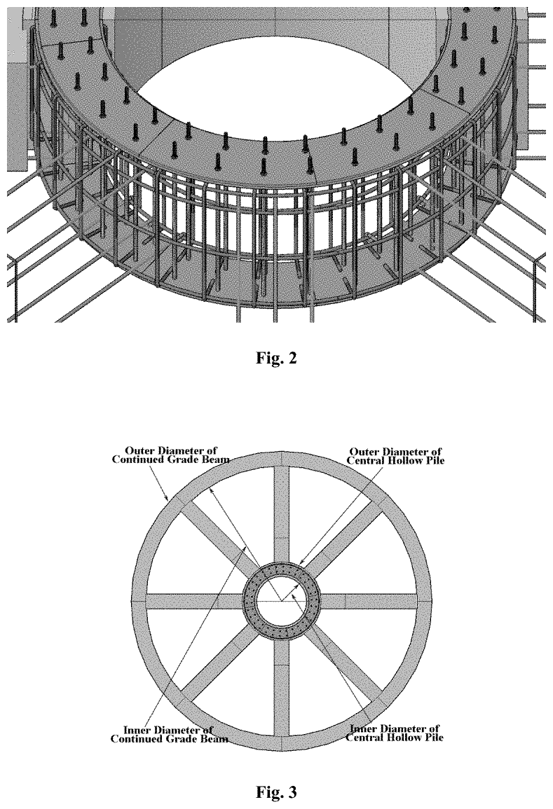

Referring specifically to the drawings, FIG. 1 and FIG. 2 are 3-D illustration for the present foundation, and FIG. 3 designates the top plan view of the invention. FIGS. 4 to 11 show the details for the foundation. FIG. 4 designates a vertical sectional view of the foundation, the numerals in FIG. 4 show that the foundation comprises four major structural members, central hollow pier 1, continued grade beam 2, arm grade beams 3 and solid piles 4. The configuration of the central hollow pier 1 matches the tower base flange 5, which is also shown on FIG. 1. The inner and outer diameters of the central hollow pier 1 typically range from 10 feet to 18 feet for wind turbine generator foundation to accommodate the base flange 5 which sits in the grouting trough 6 shown in FIG. 5. The grouting trough 6 is constructed on the top of the central hollow pier 1. The depth of the grouting trough 6 typically ranges 2 to 5 inches, and its width and diameters are wider than the tower base flange 5. The length of central hollow pier 1 is typically set as 6 feet and functions as a hub to take the loadings as well as to transfer and distribute the loadings further and deeper to continued grade beam 2 and solid piles 4 built below the continued grade beam 2 through arm grade beams 3.

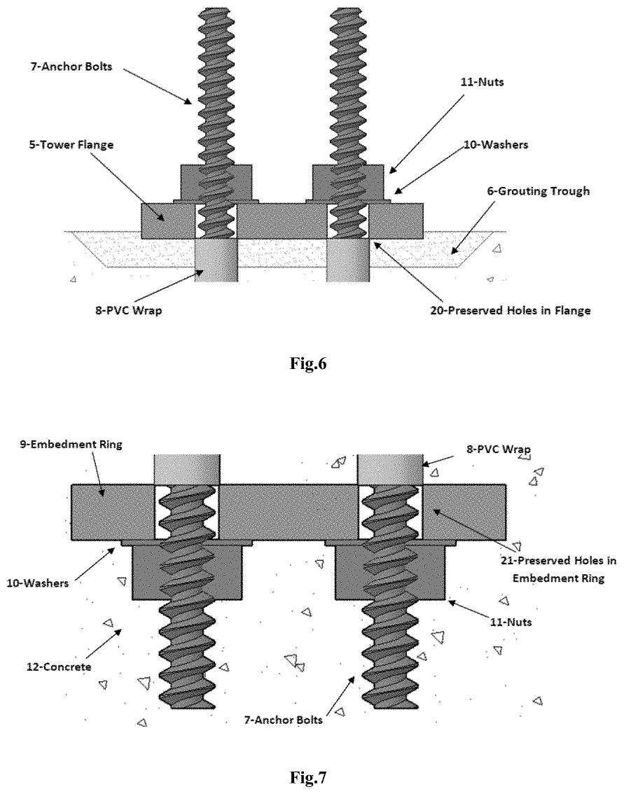

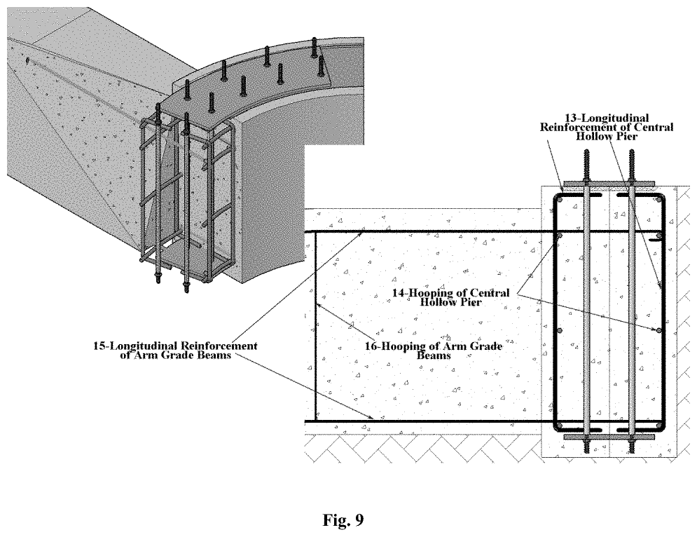

As shown in FIG. 5 and FIG. 9, the central hollow pier 1 contains a series of reinforcements, including 13 designating the longitudinal reinforcements of central hollow pier 1 and 14 designating the hooping of central hollow pier 1. Arm grade beams 3 connect to the central hollow pier 1, thus the longitudinal reinforcements designated by numeral 15 for arm grade beams 3 are extended into the central hollow pier 1. The longitudinal reinforcements 13 are curved inwardly at the top and the bottom of the central hollow pier 1 to provide more pull-out resistance capacity for the anchoring system, whereas the hooping for central hollow pier 1 designated by numeral 14 uses curved steel bars, arranged with 4 or 5 layers and placed next to the longitudinal reinforcements 13. The anchoring system is also shown in FIG. 5, while more details are shown in FIGS. 6 and 7. The anchoring system comprises of tower base flange 5, embedment ring 9, anchor bolts 7, PVC wrap 8, washers 10, and nuts 11. The tower base flange 5 positions on the top of grouting trough 6, the embedment ring 9 is placed on the bottom of the central hollow pier 1 and embedded in concrete 12. The anchor bolts 7 are assembled through and within the reinforcements, and the PVC wrap 8 is used to separate the anchor bolts 7 from concrete 12. Washers 10 and nuts 11 are placed above the base flange 5 and below the embedment ring 9, respectively. Anchor bolt 7 extrudes through the preserved holes 20 in base flange 5, and predrilled holes 21 in embedment ring 9. Post-tension on anchor bolts 7 can be applied by fastening the nuts 11 after concrete 12 hardens and reaches a designed strength.

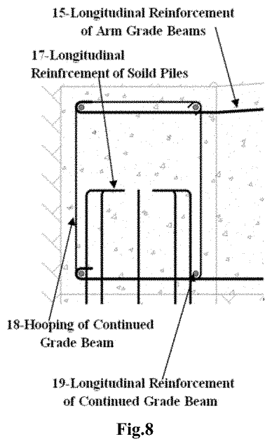

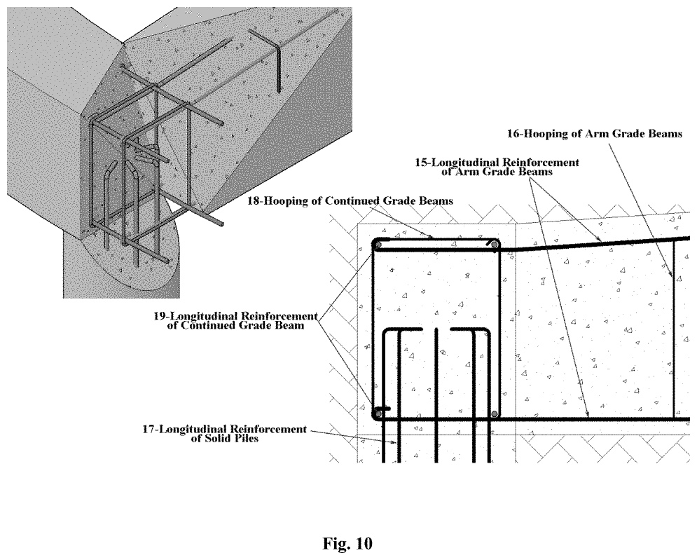

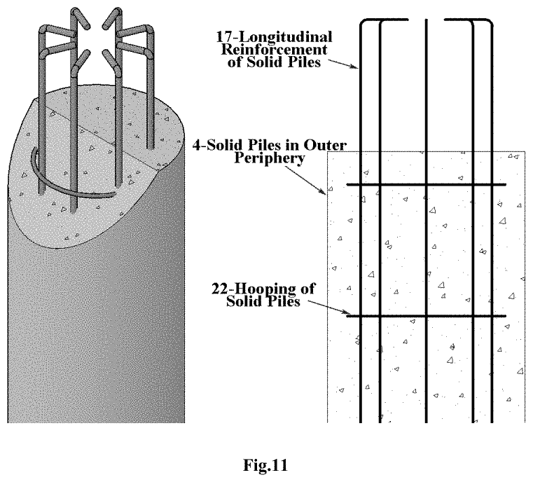

FIG. 8 and FIG. 10 show the reinforcements in continued grade beam 2, details of connection for continued grade beam 2, solid piles 4 and arm grade beams 3. The width of the continued grade beam 2 usually uses the same as the diameter of solid piles 4, a diameter of 3 feet is typically used but sometimes varies with the subsurface conditions and the loadings distributed to the solid piles 3. The height of the continued grade beam 2 is determined by the distributed loadings too, but typically 4 feet. The length of arm grade beams 3 typically adopts 15 to 25 feet. With this length, the dimensions of the solid piles 4, including its diameter and the embedment depth, which typically uses 50 to 70 feet below the continued grade beam 2, can be optimized. The top of the arm grade beams 3 levels with ground surface at the end with approximately 3 feet offset from the wall of the central hollow pier 1, and then slopes down to embed in ground and matches the top of the continued grade beam 2. The height of arm grade beams 3 at connection with central hollow pier 1 is approximately 5 feet shown in FIG. 4 and FIG. 5, principally it equals the length of the central hollow pier 1 reduced by the stickup and the part for embedment ring 9. The width typically uses 3 to 4 feet to fully utilize the mechanical properties of the reinforced concrete beam to resist the moment transferred and distributed from the central hollow pier 1. Numerals 18 and 19 designate hooping and longitudinal reinforcements for continued grade beam 2, respectively. Reinforcements 19 are curved, arranged circumferentially within the continued grade beam 2 in two layers, while hooping 18 hoop the reinforcements 19 with a spacing say 3 feet. Numeral 15 designates longitudinal reinforcements for arm grade beams 3, and the longitudinal reinforcements 15 extend into the connections of continued grade beam 2, arm grade beams 3 and solid piles 4, as well as the central hollow pier 1. Two layers are typically used for reinforcements 15, each layer contains 3 steel bars. Numeral 16 designates the hooping for arm grade beams 3. Similarly the hooping 16 hoop the reinforcements 15 with a spacing say 3 feet.

FIG. 11 shows the solid piles 4 and the reinforcements. Numeral 17 designates the longitudinal reinforcements for piles 4. Reinforcements 17 typically use 8 vertical steel bars, arranged circumferentially along the perimeter of the solid piles 3. Reinforcements 17 may be staggered to save the steel, and extend into the connections with continued grade beam 2 and arm grade beams 3. Reinforcements 17 are curved inwardly at the top. Hooping 22 hoops the vertical reinforcements 17 with a spacing 3 feet, sometimes spiral-like reinforcements can be used for hooping 22.

The following construction steps are for illustrative purpose only, and may be adjusted in accordance with project conditions:
1. Level the construction site. Delineate the locations for the above mentioned four major structural members 1, 2, 3 and 4.
2. Fabricate reinforcement for central hollow pier 1, continued grade beam 2, solid piles 4 and arm grade beams 3 per design drawings.
3. Assembled embedment ring 9 and anchor bolts 7. A template ring may be needed to ensure the anchor bolts 7 positioning accurate and vertical.
4. It is ideal to assemble the embedment ring 9 and anchor bolts 7 within reinforcements for short central hollow pier 1 prior to place reinforcements for central hollow pier 1 to the trench described below.
5. Drill the holes for solid piles 4 to the designed depth. Bentonite slurry may be needed during hole drilling to prevent caving when subsurface geomaterial are sands.
6. Excavate trenches for the central hollow pier 1, continued grade beam 2 and arm grade beams 3 using backhoe or other trenching equipment. Bentonite slurry may be needed during trenching to prevent caving when subsurface geomaterial are sands.
7. Set up auxiliary equipment such as pullies/cranes. The equipment will be used to stabilize the embedment ring 9 and anchor bolts 7 in central hollow pier 1, and will be used to place reinforcements to the excavated trenches.
8. Place reinforcements fabricated per design drawing to the drilled holes for solid piles 4. Prior to reinforcement placement, proceed with QA/QC checking for deposits at the bottom of the holes per industry standards.
9. Holes may need to use recycled tap water to replace the slurry to ensure no mud bond to the reinforcement if slurry is used to prevent caving per industry standards.
10. Using the auxiliary equipment such as pullies/cranes to place reinforcements in the trench for continued grade beam 2, arm grade beams 3, short central hollow pier 1.
11. Place embedment ring 9 and anchor bolts 7 within the reinforcements for central hollow pier 1. If the embedment ring 9 and anchor bolts 7 are assembled within reinforcements for short central hollow pier 1, skip this step.
12. Use recycling water to bring the slurry out if slurry is used during trenching and ensure reinforcements clean from slurry per industry standards in relation to pier/pile/wall foundation.
13. Using tremie pipe to place concrete 12 from the bottom of the solid piles 4.
14. Place concrete 12 to the trenches for continued grade beam 2 and arm grade beams 3, when the concrete 12 is placed to the level matches the bottoms of continued grade beam 2 and arm grade beams 3.
15. Step 14 can be proceeded one by one, not necessary to proceed together, but the time for concrete placement shall comply with industry standards to avoid cold joints in concrete.
16. Continue to place concrete 12, to the trench for central hollow pier 1. Prior to placement for concrete 12, ensure all reinforcements, embedment ring 9 and anchor bolts 7, as well as apparatus and/or preserved conduits for electrical cables/wires, are in right position.
17. Place two concentric steel cases to the concrete surface, which to be used to shape the foundation stickup in central hollow pier 1. The outer steel case should have a “door” which is used to pass though the possible steel strings being used to hang the template ring and anchor bolts 7, as well as reinforcements for short central hollow pier 1.
18. Place concrete to the two concentric steel cases to form stickup for foundation.
19. Restore on-site soils above the structural members per design; move the steel cases out and clean them to prepare for using with the next foundation.
20. Cure placed concrete 12 by keeping the restored fill moistured or using other measures to cure the poured concrete 12.
21. When concrete at the top of the pier 1 are hardened, install the flange of superstructure to the grout trough 6, level the base flange 5 and ensure the anchor bolts 7 vertical.
22. Grout the grout trough 6.
23. When foundation concrete and the grout reach the designed strength, apply tensions to anchor bolts 7 by fastening the nuts 11.
24. Move the auxiliary equipment to the next foundation and repeat the steps for next foundation.

The above description uses examples to disclose the invention, and to enable any person skilled in the art to practice the invention, including making and using any forms and features and performing any incorporated methods. All the dimensions for the four major structural members and the reinforcement shape, size and grade shall be detailed in design phase. The construction steps described above are duly for further clarification for construction of the invented foundation, the construction steps may be adjusted and optimized per project conditions. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. The present foundation comprises the following structural members:
a short central hollow pier 1, a continued grade beam 2, several arm grade beams 3 and several solid piles 4 arranged circumferentially in outer periphery of the present foundation.
The short central hollow pier 1 positions in the center of the foundation, the continued grade beam 2 positions in outer periphery of the system, solid piles 4 are built below the continued grade beam 2, and arm grade beams 3 connect the central hollow pier 1 to continued grade beam 2 and solid piles 4.
Solid piles 4 and the arm grade beams 3 have the same quantity.

2. The outer and inner diameters of the central hollow pier 1, typically matching the configuration of superstructure, are larger than the diameter of solid piles 4 arranged circumferentially in outer periphery.

3. The inner and outer diameters of the continued grade beam 2 are much larger than the diameters of the short central hollow pier 1 to enable the present foundation functions as invented.

4. The short central hollow pier 1 in the present foundation is a short hollow structure in round or regular polygonal shape, solid piles 4 are solid structure in round or square shape, and the continued grade beam 2 and arm grade beam 3 are solid structures in rectangular or square shape.

5. The arm grade beams 3 extend from the wall of the short central hollow pier 1 to continued grade beam 2 as well as solid piles 4 and have a varied section with the height increasing from connection to solid piles 4 to the central hollow pier 1.

6. Diameter of solid piles 4 may not necessarily equals the width of the continued grade beam 2.

7. All structural members of the present foundation are constructed of cast-in-place concrete reinforced with rebars, and all connections for the structural members are fixed and rigid.

8. The short central hollow pier 1 works as a hub to take the loadings from superstructures by utilizing the anchoring system embedded within the wall concrete, and transfers and distributes the loadings to continued grade beam 2 arranged in further location as well as solid piles 4 embedded in deep ground through the arm grade beams 3.

9. The quantity and dimensions for the structural members, as well as the shapes, sizes and grades of the reinforcements, of the present foundation may vary in accordance with the site and loading conditions.
